(19) United States
(12) Patent Application Publication
(10) Pub. No.: US 2004/0120423 A1
(43) Pub. Date: Jun. 24, 2004

(54) Device and method for compensating for a direct voltage offset and for adjusting a decision threshold for optical data transmission networks

(76) Inventors: Martin Clara, Villach (AT); Alexander Kahl, Villach (AT); Martin Trojer, Klagenfurt (AT); Andreas Wiesbauer, Portschach (AT)

Correspondence Address: Aaron Wininger, Squire Sanders & Dempsey, 600 Hansen Way, Palo Alto, CA, 94304-1043, US

(21) Appl. No.: 10/476,712

(22) PCT Filed: Apr. 25, 2002
(86) PCT No.: PCT/EP02/04591

(30) Foreign Application Priority Data
May 4, 2001 (DE) 101 21 715.3

(51) Int. Cl. H04L 25/06; H04L 25/10

(52) U.S. Cl. 375/319

(57) ABSTRACT

Circuit arrangement for evaluating an information signal and a method for adjusting a circuit arrangement of this type.

In particular in optical data transmission networks, disruptive offset voltages can occur in the case of direct current-coupled receiving circuits which may be caused by a basic level of the transmitters of the light signals. Owing to different transmission paths, the amplitudes of the information signals may also be very different, so a different threshold value is necessary for a comparator circuit (8), depending on the amplitude, to recover the bit sequence. For this purpose, the steady component is measured at the input or output of an amplifying circuit (3) in a first step, and depending on this, a correction value is formed for offset compensation and a further measurement of the information signal then takes place at the output of the amplifying circuit (3) in a second step with the correction value superimposed to determine a suitable threshold value for the comparator circuit (8). The correction value or the threshold value is ascertained at each transmitter and stored in a memory arrangement (18, 19). To evaluate the information signal of a specific transmitter, the correction value or threshold value stored for this transmitter is superimposed at the amplifying circuit (3) or the comparator circuit (8).

### DESCRIPTION

The following invention relates to a circuit arrangement for evaluating an information signal and a method for adjusting a circuit arrangement of this type.

Circuit arrangements for evaluating an information signal are used in particular in data transmission systems, in which a transmitter transmits an information signal containing data or information and a receiver has to extract the transmitted data or information from the information signal or has to evaluate the information signal. During transmission of the information signal from the transmitter to the receiver, the signal is generally changed, however, with the change in the information signal depending substantially on the transmission path. The influence of the transmission path on the information signal may in addition be subject to further influences and be changeable with respect to time. When a plurality of transmitters are present in one data transmission system and transmit their information signals on various transmission paths to the receiver, in some circumstances the receiver has to evaluate very different information signals. Thus, for example, an information signal transmitted over a transmission path with high damping may have a substantially lower level than an information signal transmitted over a transmission path with low damping. The transmitters themselves may also transmit information signals at various amplitudes. The information signal may, in addition, have a changing steady component in some data transmission networks, such as, for example optical networks, if the light sources used to transmit the information signal have a specific basic brightness.

A data receiving circuit for optical data transmission networks with a plurality of transmitters is known from EP 586 746 A1, the information signal coming from an optical receiver being amplified in the data receiving circuit and the amplified signal being evaluated by a comparator to obtain the data bits. A control device is also provided which ascertains and stores a suitable threshold value for the comparator for each transmitter. To evaluate the information signals of the various transmitters, the control device supplies the comparator with the value, as the threshold value, which is stored as the suitable threshold value for the transmitter, the information signal of which is to be currently evaluated. Disadvantageously, the direct current offset must also be compensated in a preamplifier to determine the threshold value and a higher circuit outlay for an extreme value determination and an adequately precise analogue/digital conversion or digital/analogue conversion are necessary for determining the suitable threshold values.

The object of the present invention is to provide a circuit arrangement and a method of the type mentioned at the outset in which a circuit arrangement for detecting an information signal can be quickly adjusted to the situation with low outlay in the case of a specific information signal.

This object is achieved according to the invention by a circuit arrangement with the features of claim 1 and a method with the features of claim 8. The sub-claims in each case define preferred and advantageous embodiments of the present invention.

The circuit arrangement according to the invention has a respective analogue/digital converter to correct an offset of the information signal and to adjust a suitable threshold value. On the one hand this has the advantage that an offset compensation can be dispensed with in the case of upstream preamplifiers and, on the other hand, that the digital/analogue converters may have a lower resolution, so the circuit outlay can be reduced. If, for example, an offset of the information signal cannot be completely compensated by the first digital/analogue converter, it can still be corrected via the threshold value by the second digital/analogue converter, an over-control of the amplifier being avoided by the at least rough offset compensation.

Offset compensation by means of a digital/analogue converter, compared to other circuits for offset compensation, has the advantage that the digital/analogue converter allows the value suitable for offset compensation to be loaded very quickly, wherein this value can also be loaded into the digital/analogue converter prior to reception of the corresponding information signal, if the value is already known in advance.

If the first amplitude value is ascertained upstream from the amplifying circuit for offset compensation for adjustment of the first digital/analogue converter, even very large offset values can be reliably detected as the information signal at this point has not yet been amplified by the amplifying circuit.

If, on the other hand, the first amplitude value is measured at the output of the amplifying circuit, an offset of the amplifying circuit itself can also be compensated in this manner. In addition, a higher signal level is present at the output of the amplifying circuit, so a voltage range which is possibly more favourable for an analogue/digital converter, can be achieved and small offset values can also be measured at a higher resolution.

It is also insignificant here for the invention whether the signals are voltage or current signals and whether the signals are differential.

When the first amplitude value is measured at the output of the amplifying circuit or downstream from the amplifying circuit, both the first amplitude value and the second amplitude value can be ascertained with a single analogue/digital converter. The first amplitude value is initially ascertained for this purpose with an analogue/digital converter of this type, the offset compensation is carried out by outputting the correction value to the first digital/analogue converter and then the second amplitude value is ascertained with the same analogue/digital converter to determine the threshold value.

It is also possible to repeatedly ascertain the first amplitude value and determine the correction value therefrom. This is particularly recommended in cases in which the superimposition of the correction value affects the first amplitude value, so the correction value can be checked in this manner and optionally a new improved correction value can be ascertained. This procedure is also recommended in cases in which the first amplitude value is ascertained at the output of the amplifying circuit and the information signal has an offset which is so high that the output of the amplifying circuit runs at saturation. In a case such as this, the first amplitude value can no longer be correctly ascertained, as it has been limited by the output stage of the amplifying circuit. In a case such as this, a first correction value can initially be determined as a remedy and superimposed to shift the output signal of the amplifying circuit into a linear range, and then the first amplitude value can be determined a second time and a second and more precise correction value determined as a function thereof.

If the circuit arrangement according to the invention is used together with a plurality of transmitters of information signals, a memory device in which the associated correction value and the associated threshold value are stored for each transmitter can be provided in the control device. When the information signal from a specific transmitter is to be evaluated, the correction value and threshold value stored for this transmitter can be loaded in the first or second digital/analogue converter. It can be established for this purpose, with the aid of a received signal, which transmitter transmits when. For example, time slots may be provided which are allocated to the various transmitters, so the information is present in the control device as to when which transmitter transmits so that the suitable correction value or threshold value can be loaded on time in advance.

To determine the correction value or the threshold value for the individual transmitters it may be provided that the transmitters transmit test signals, with the aid of which the circuit arrangements can determine the correction value or the threshold value. The transmitters can either transmit these test signals independently, for example at specific intervals, or on the request of the circuit arrangement according to the invention.

Once the correction value or threshold value has been determined for a specific transmitter it is stored and used during the evaluation of an information signal transmitted by this transmitter until a new correction value or threshold value is determined and stored. The old correction value or threshold value may be overwritten here.

The invention will be described in more detail hereinafter with the aid of a preferred embodiment and with reference to the accompanying drawing.

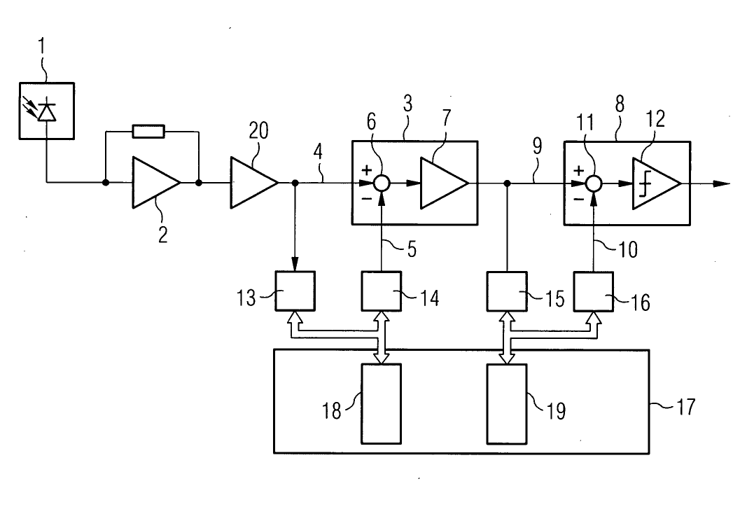

FIG. 1 shows a block diagram of a circuit arrangement for evaluating an information signal according to the embodiment of the present invention.

The circuit arrangement shown in FIG. 1 serves to evaluate information signals transmitted in an optical network. For this purpose, the circuit arrangement has an optical receiver in the form of a photodiode 1, of which the photocurrent is converted by a transimpedance amplifier 2 into a voltage signal. A buffer stage 20 is connected downstream from the transimpedance amplifier 2, the buffer stage 20 being optional, however. Owing to the different situations of the transmitters and the transmission paths, the information signal at the output of the buffer stage 20 is loaded with alternating offset voltages, the useful signal contained also having different amplitude values.

The output of the buffer stage 20 is connected, on the one hand, to a first analogue/digital converter 13 and, on the other hand, to an input 4 of an amplifying circuit 3. The amplifying circuit 3 has an amplifier 7, upstream of which a subtractor 6 is connected, at the positive input 4 of which the information signal is present and of which the negative input 5 serves to superimpose a correction value to compensate the offset voltage of the information signal. For this purpose, the output of a first digital/analogue converter 14 is connected to the negative input 5 of the amplifying circuit 3.

To extract the individual bits from the bit sequence transmitted with the information signal, a comparator circuit 8 is provided which has a comparator 12 with an upstream subtractor 11. The subtractor 11 of the comparator circuit 8 also has a positive input 9 and a negative input 10 which serves to apply a threshold value for the comparator circuit 8.

The positive input 9 of the comparator circuit 8 is connected to the output of the amplifying circuit 3. The negative input 10 of the comparator circuit 8 is connected to the output of a second digital/analogue converter 16 to generate the threshold value. A second analogue/digital converter 15 is also connected to the output of the amplifying circuit 3.

The circuit arrangement also has a control device 17 which serves to determine the correction value for the offset compensation in the amplifying circuit 3 or to determine the threshold value for the comparator circuit 8.

The control device 17 has a first memory arrangement 18 for storing a plurality of correction values for various transmitters and a second memory arrangement 19 for storing a plurality of threshold values for various transmitters. The first memory arrangement 18 is connected to the first analogue/digital converter 13 and the first digital/analogue converter 14, whereas the second memory arrangement 19 is connected to the second analogue/digital converter 15 and the second digital/analogue converter 16.

Also, a transmitting device, not shown, with which the control device 17 can transmit in particular a request signal to the transmitter, not shown, is associated with the control device 17. Transmitters can be induced with this request signal to transmit, for their part, a test signal.

To ascertain the correction value and the threshold value for a specific transmitter, the control device 17 transmits a request signal for this specific transmitter which on receiving the request signal transmits a test signal. The test signal contains a first block with a plurality of logical ones, a second block with a plurality of logical zeros, a third block with a plurality of logical ones and a fourth block with a plurality of logical zeros. In a variation, instead of the blocks with logical zeros, dark signals can be transmitted in which the light transmitter is switched off.

The control device 17 awaits the test signal within a specific time period after transmitting the request signal and starts determining the correction value or threshold value on reception of the first block with logical ones. For this purpose, a first upper value is measured by means of the first analogue/digital converter 13 during reception of the first block with logical ones, and a first lower value is measured during reception of the second block with logical zeros. The control device 17 then forms the mean value between the first upper and the first lower value which provides the steady component of the information signal. A correction value is then determined as a function of this ascertained steady component and is stored in the circuit arrangement 18 for this specific transmitter. At the time the determined correction value is superimposed by means of the first digital/analogue converter 14 at the negative input 5 of the amplifying circuit 3, so the steady component is subtracted in the subtractor 6 from the information signal at the input 4. The now offset-compensated information signal is amplified by the amplifier 7 and routed to the comparator circuit 8 and the second analogue/digital converter 15.

In the second step, with the correction value applied, the threshold value for this transmitter is determined, in that a second upper value is ascertained by means of the second analogue/digital converter 15 during reception of the third block with logical ones, and a second lower value is ascertained during reception of the fourth block with logical zeros. The control unit 17, as in the above case, forms the mean value between the second upper and the first lower value and stores this as the threshold value in the second memory arrangement 19. This threshold value is superimposed by means of the second digital/analogue converter 16 on the negative input of the comparator circuit 8.

This determination of the correction value or the threshold value is carried out for each transmitter present in the data transmission system, so a suitable correction value or threshold value is stored in the two memory arrangements 18, 19 for each transmitter.

The transmitters transmit their information signals at established times in each case which are known to the control device 17. Thus to evaluate an information signal transmitted by a specific transmitter, the control device 17 can output in advance the corresponding correction value from the first memory arrangement 18 to the amplifying circuit 3 by means of the first digital/analogue converter 14 and the corresponding threshold value from the second memory arrangement 19 to the comparator circuit 8 by means of the second digital/analogue converter 16. Now before the information signal is received from the transmitter, the circuit arrangement is already adjusted so that the offset of the information signal being adjusted in the case of this transmitter is compensated and the correct threshold value is adjusted for this transmitter.

Transmission of the request signals to determine the correction values or threshold values for the individual transmitters takes place at arbitrary or regular intervals which may be, for example, one second. A request signal is also transmitted for the transmitters which have just logged on in the data transmission network.

1. Circuit arrangement for evaluating an information signal comprising an amplifying circuit which has an input for the information signal and an input for a correction value for shifting the level of the information signal, a comparator circuit for comparing the information signal amplified by the amplifying circuit with a threshold value, a first digital/analogue converter for generating the correction value and a second digital/analogue converter for generating the threshold value, a measuring device for ascertaining a first amplitude value of the information signal upstream from the comparator circuit and for determining a second amplitude value of the information signal between the amplifying circuit and the comparator circuit, and comprising a control device which is set up in such a way that it firstly ascertains the first amplitude value by means of the measuring device, determines the correction value as a function of the ascertained first amplitude value and outputs it to the amplifying circuit by means of the first digital/analogue converter and then ascertains the second amplitude value by means of the measuring device, determines the threshold value as a function of the ascertained second amplitude value and outputs it to the comparator circuit by means of the second digital/analogue converter.

2. Circuit arrangement according to claim 1, wherein the inputs of the amplifying circuit and the comparator circuit and the outputs of the amplifying circuit and the two digital/analogue converters are designed to be differential.

3. Circuit arrangement according to claim 1 or 2, wherein the measuring device is set up in such a way that it ascertains the first amplitude value of the information signal upstream from the amplifying circuit.

4. Circuit arrangement according to claim 1 or 2, wherein the measuring device is set up in such a way that it ascertains the first amplitude value of the information signal downstream from the amplifying circuit.

5. Circuit arrangement according to one of claims 1-4, wherein the measuring device has a first digital/analogue converter for ascertaining the first amplitude value of the information signal and a second digital/analogue converter for ascertaining the second amplitude value of the information signal.

6. Circuit arrangement according to one of claims 1-5, wherein the control device is set up in such a way that it repeatedly ascertains the first amplitude value by means of the measuring device prior to ascertaining the second amplitude value, determines the correction value as a function of the ascertained first amplitude value and outputs it to the amplifying circuit by means of the first digital/analogue converter.

7. Circuit arrangement according to one of claims 1-6, wherein the control device has a memory device for storing a plurality of correction values and threshold values and is set up in such a way that it selects a specific stored correction value and a specific stored threshold value as a function of a signal describing an information signal transmitter and outputs it by means of the first or second digital/analogue converter.

8. Method for adjusting a circuit arrangement for evaluating an information signal comprising an amplifying circuit which has an input for the information signal and an input for a correction value for shifting the level of the information signal, a comparator circuit for comparing the information signal amplified by the amplifying circuit with a threshold value, a first digital/analogue converter for generating the correction value and a second digital/analogue converter for generating the threshold value, a measuring device for detecting a first amplitude value of the information signal upstream of the comparator circuit and for determining a second amplitude value of the information signal between the amplifying circuit and the comparator circuit, and comprising a control device, in which method initially a first amplitude value is ascertained, the correction value is determined as a function of the ascertained first amplitude value and is output to the amplifying circuit by means of the first digital/analogue converter and then a second amplitude value is ascertained, the threshold value is determined as a function of the ascertained second amplitude value and is output to the comparator circuit by means of the second digital/analogue converter.

9. Method according to claim 8, wherein the correction value and the threshold value are determined for a plurality of respective information signals transmitted by a specific one of a plurality of information signal transmitters and are stored with allocation to the specific information signal transmitter, and to evaluate an information signal transmitted by this specific information signal transmitter, the correction value stored for this specific information signal transmitter is output to the amplifying circuit by means of the first digital/analogue converter, and the threshold value stored for this specific information signal transmitter is output to the comparator circuit by means of the second digital/analogue converter.

10. Method according to claim 8 or 9, wherein the correction value and the threshold value are determined during reception of a test signal.

11. Method according to claim 10, wherein the test signal from an information signal transmitter transmits upon a request signal transmitted by the circuit arrangement.
